(19) United States
(12) Patent Application Publication
(10) Pub. No.: US 2013/0046827 A1
(43) Pub. Date: Feb. 21, 2013

(54) DOCUMENT MANAGEMENT SERVER APPARATUS, SYSTEM, NEWLY-ARRIVED DOCUMENT NOTIFICATION METHOD, AND STORAGE MEDIUM

(71) Applicant: Masaya Soga, Yokohama-shi (JP)

(72) Inventor: Masaya Soga, Yokohama-shi (JP)

(73) Assignee: CANON KABUSHIKI KAISHA, Tokyo (JP)

(21) Appl. No.: 13/586,141

(22) Filed: Aug. 15, 2012

(30) Foreign Application Priority Data
Aug. 17, 2011 (JP) 2011-178474

(51) Int. Cl. G06F 15/16

(52) U.S. Cl. 709/204

(57) ABSTRACT

When notifying of a newly-arrived document, it is determined whether a newly-arrived document confirmation is not received from a client apparatus even after a set newly-arrived document confirmation time has elapsed, and whether the newly-arrived document confirmation is received from the client apparatus when the set newly-arrived document confirmation time has elapsed. If it is determined that the newly-arrived document confirmation is not received from the client apparatus even after the set newly-arrived document confirmation time has elapsed, a mobile terminal apparatus is notified of a document which newly arrives after a time at which the client apparatus confirmed the newly-arrived document. If it is determined that the newly-arrived document confirmation is received from the client apparatus when the set newly-arrived document confirmation time has elapsed, the client apparatus is notified of the newly-arrived document.

### BACKGROUND OF THE INVENTION

1. Field of the Invention

The present invention relates to a document management server apparatus, a system, a newly-arrived document notification method, and a storage medium.

2. Description of the Related Art

Conventionally, there is a configuration in which a server provides services to a client apparatus. For example, there is a technique in which the client apparatus transmits to and receives from the server a document, and the server performs document management.

In recent years, a cloud computing system has attracted attention. In the cloud computing system, various applications running on a server computer on the Internet can be used to reduce management and maintenance costs of in-house servers and the applications.

Further, mobile terminals represented by cellular phones, such as iPhone (registered trademark) and in which Android (registered trademark) operating system (OS) is installed, have become popular. A user using the mobile terminal is capable of receiving and viewing a document on the mobile terminal in addition to a client personal computer (PC). In such a case, how to use the client PC and the mobile terminal to receive a notification of a newly-arrived document may become an issue. Japanese Patent Application Laid-Open No. 2010-226308 discusses a technique in which, if a user uses both the client PC and the mobile terminal, the newly-arrived document notification can be issued to the appropriate terminal based on a login status of the user on each terminal.

However, there may be a case that the terminal has been remained in the login state, thus it cannot be determined whether the user is actually using the terminal or not from the login state. In such a case, the newly-arrived document notification cannot be transmitted to the appropriate terminal.

### SUMMARY OF THE INVENTION

According to an aspect of the present invention, a document management server apparatus including a determination unit configured to determine, when notifying of a newly-arrived document, whether a newly-arrived document confirmation is not received from a client apparatus even after a set newly-arrived document confirmation time elapsed, and whether a newly-arrived document confirmation is received from the client apparatus when the set newly-arrived document confirmation time elapsed, and a notification unit configured to notify, in the case where the determination unit determines that the newly-arrived document confirmation is not received from the client apparatus after the set newly-arrived document confirmation time elapsed, a mobile terminal apparatus of a document which newly arrives after a time at which the client apparatus confirmed the newly-arrived document, and notify, in the case where the determination unit determines that the newly-arrived document confirmation is received from the client apparatus when the set newly-arrived document confirmation time elapsed, the client apparatus of the newly-arrived document.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a document management system.

FIG. 2 illustrates a hardware configuration of each apparatus and server included in the document management system.

FIG. 3 illustrates a software configuration of each apparatus and server included in the document management system.

FIG. 4 illustrates an example of a user interface of a mobile terminal application.

FIG. 5 illustrates an example of a user interface of a dedicated application.

FIG. 6 is a flowchart illustrating a newly-arrived document notification target folder setting process according to a first exemplary embodiment of the present invention.

FIG. 7 illustrates an example of newly-arrived document notification target folder information data to be transmitted.

FIG. 8 illustrates an example of a newly-arrived document notification target folder information management table which stores newly-arrived document notification target folder information data described in extensible markup language (XML).

FIG. 9 is a flowchart illustrating a newly-arrived document confirmation process according to the first exemplary embodiment.

FIG. 10 is a flowchart illustrating a newly-arrived document notification process according to the first exemplary embodiment.

FIG. 11 illustrates an example in which checking is performed at each newly-arrived document confirmation timing.

FIG. 12 illustrates an example of a newly-arrived document list display on a mobile terminal.

FIG. 13 is a flowchart illustrating a newly-arrived document confirmation process according to a second exemplary embodiment.

FIG. 14 is a flowchart illustrating a newly-arrived document notification process according to the second exemplary embodiment.

FIG. 15 illustrates an example of a newly-arrived document confirmation process execution time.

### DESCRIPTION OF THE EMBODIMENTS

Various exemplary embodiments, features, and aspects of the invention will be described in detail below with reference to the drawings.

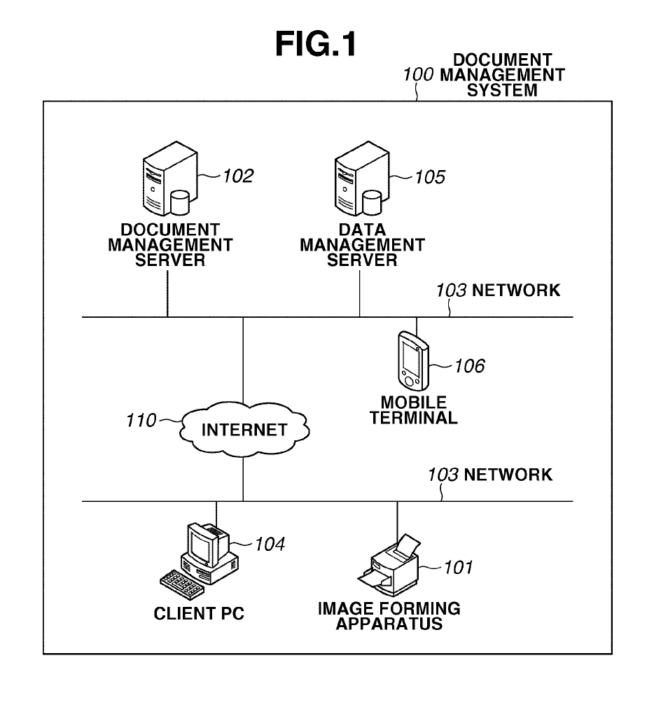

A configuration of a document management system 100 according to a first exemplary embodiment of the present invention will be described below. FIG. 1 illustrates the configuration of the document management system 100. The document management system 100 includes a client PC 104 and an image forming apparatus 101, which are arranged in a user environment and connected to each other via a network 103 and to the Internet 110. Further, the document management system 100 includes a data management server 105, a document management server 102, and a mobile terminal 106.

The data management server 105, the document management server 102, and the mobile terminal 106 are connected to each other via the network 103 and to the Internet 110. According to the first exemplary embodiment, the data management server 105 and the document management server 102 are connected via the network 103. However, the data management server 105 and the document management server 102 may be connected via the Internet 110. The document management system 100 includes one client PC 104 and one image forming apparatus 101 in FIG. 1. However, the document management system 100 may include a plurality of the respective apparatuses. Further, the document management system 100 includes a plurality of servers. However, the document management system 100 may also include only one server. The document management server 102 is an example of a document management server apparatus. The client PC 104 is an example of a client apparatus. The data management server 105 is an example of a data management server apparatus.

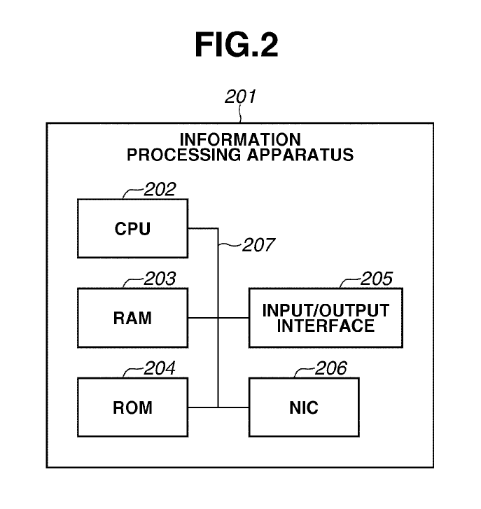

A hardware configuration of each apparatus and server included in the document management system 100 will be described below. FIG. 2 illustrates the hardware configuration of each apparatus and server included in the document management system 100.

An information processing apparatus 201 indicates each apparatus and server included in the document management system 100. A central processing unit (CPU) 202 executes various programs and realizes various functions. A read only memory (ROM) 204 stores the various programs. The CPU 202 loads the programs stored in the ROM 204 to a random access memory (RAM 203) and executes them. The RAM 203 is used as a temporary work and storage area of the CPU 202.

An input/output interface 205 is an interface unit which transmits the data to a display device (not illustrated) connected to each apparatus and server, and receives data from a pointing device (not illustrated). A network interface card (NIC) 206 is a unit for connecting each apparatus and server included in the document management system 100 to the network 103. The above-described units can transmit and receive data via a bus 207.

The image forming apparatus 101 further includes a printing unit (not illustrated) which can transmit and receive data to and from each of the units via the bus 207. The printing unit can print a raster image on a recording medium. The image forming apparatus 101 further includes a scanner unit (not illustrated) which can transmit and receive data to and from each of the units via the bus 207. The scanner unit can input an image to the image forming apparatus.

The mobile terminal 106 includes a touch panel (not illustrated) as the input/output interface 205. The touch panel has two functions, that is a display function and an input function. The touch panel thus displays image information on a display unit (not illustrated), and when the user touches a displayed picture, a point, or an area thereon, the touch panel detects information corresponding to the touched screen position and transmits the data.

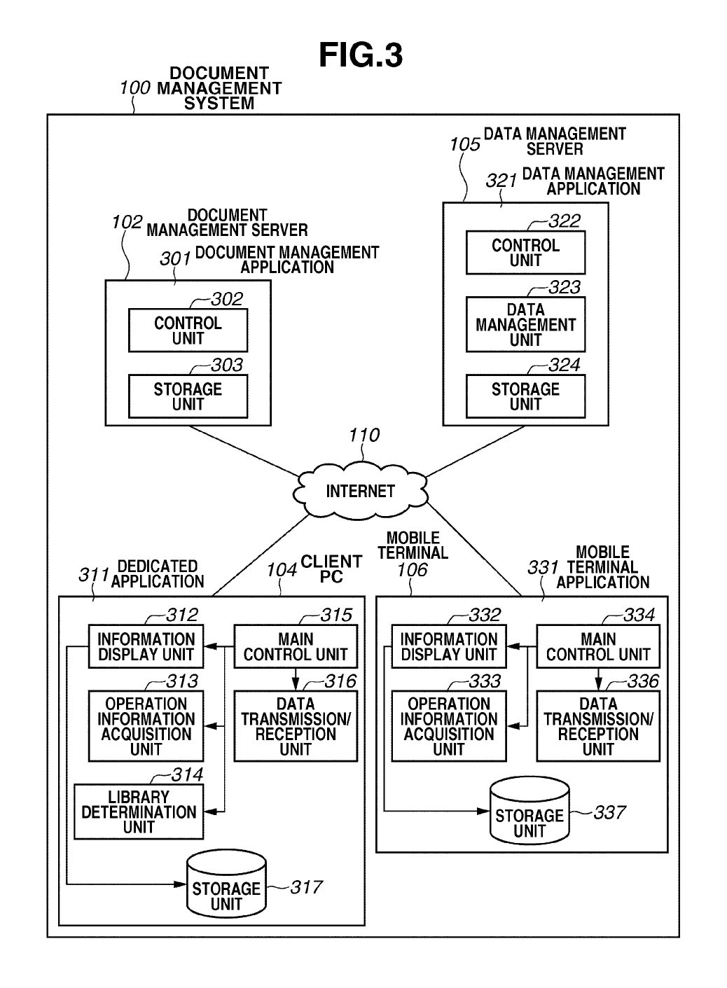

The functions of each apparatus and server included in the document management system 100 will be described below. FIG. 3 illustrates the software configuration of each apparatus and server included in the document management system 100. The programs for realizing the functions of each of the software configurations are stored in the ROM 204 in each apparatus and server. The functions are thus realized by the CPU 202 loading the programs to the RAM 203 and executing them.

The software configuration of the mobile terminal 106 will be described below. In FIG. 3, a main control unit 334 controls a mobile terminal application 331 of the mobile terminal 106 according to the present exemplary embodiment, and instructs and manages each of the units to be described below. An information display unit 332 displays the user interface of the mobile terminal application 331 of the mobile terminal 106 according to the instruction from the main control unit 334.

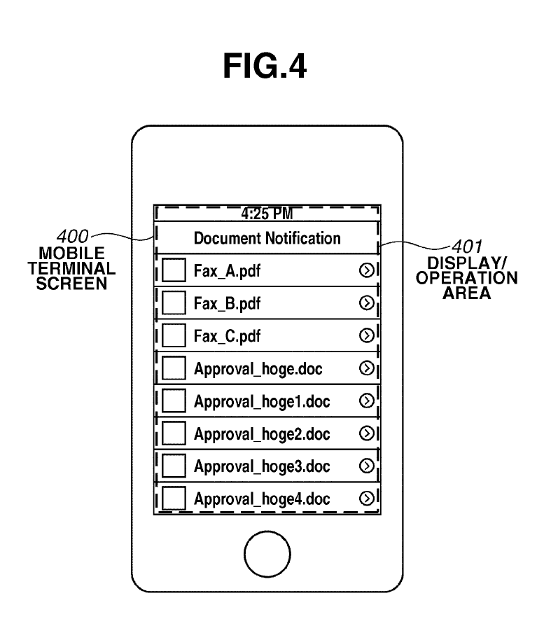

FIG. 4 illustrates an example of the user interface of the mobile terminal application 331. The user interface includes a display/operation area 401, in which a mobile terminal screen 400 with the touch panel (not illustrated) displays the document data for the user to operate the document data. When the user operates the user interface of the mobile terminal application 331, a document list and a newly-arrived document list are displayed, and the user can operate the document data. The user operations on the document data include viewing, editing, and adding annotations and comments to the document data.

A form, a configuration of an area, and control with respect to the user interface of the mobile terminal application 331 illustrated in FIG. 4 are not limited. The user interface may be in any form as long as the necessary functions can be realized.

An operation information acquisition unit 333 acquires the information operated on by the user via the user interface of the mobile terminal application 331 displayed by the information display unit 332. The operation information acquisition unit 333 then notifies the main control unit 334 of the acquired information. If the user touches a displayed picture, a point, or an area on the display/operation area 401, the operation information acquisition unit 333 detects the information corresponding to the touched screen position and transmits the data to the main control unit 334. A storage unit 337 stores setting information set by the user via the user interface of the mobile terminal application 331. A data transmission/reception unit 336 transmits and receives the data to and from the document management server 102 and the data management server 105, and notifies the main control unit 334.

The software configuration of the client PC 104 will be described below. In FIG. 3, a main control unit 315 controls a dedicated application 311 of the client PC 104 according to the present exemplary embodiment of the present invention, and instructs and manages each of the units to be described below. An information display unit 312 displays a user interface of the dedicated application 311 on the client PC 104 according to the instruction from the main control unit 315.

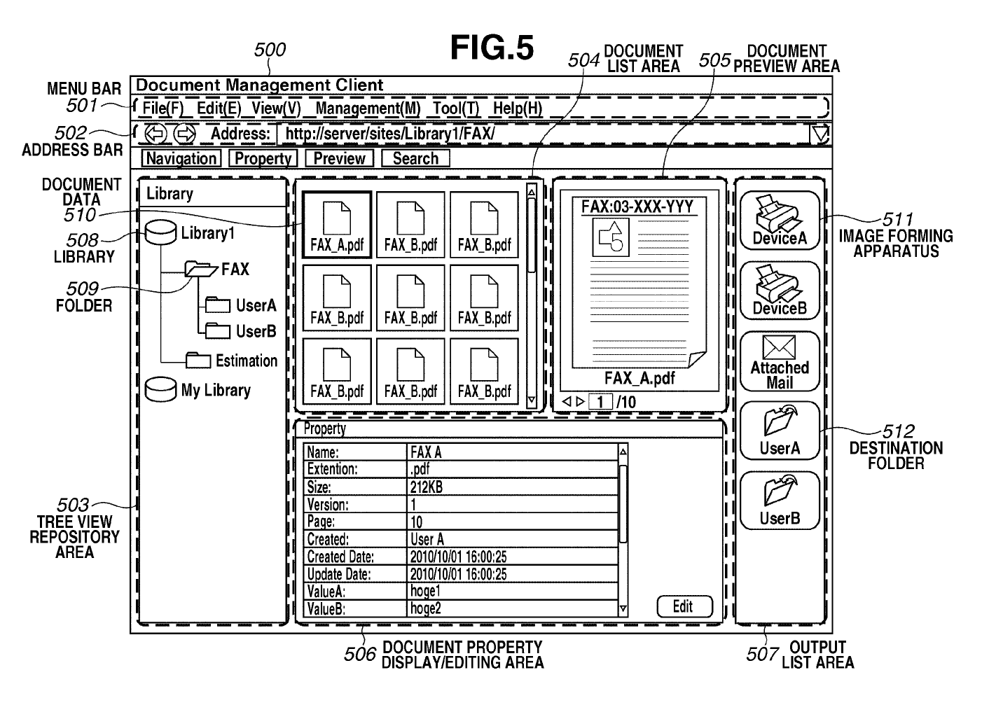

FIG. 5 illustrates an example of the user interface of the dedicated application 311. A repository area 503 which displays repository information includes folders 509 and libraries 508 in a tree view form. A document list area 504 displays document data 510 in the form of a thumbnail or an icon. A document preview area 505 for displaying a preview image and a document property display/editing area 506 for displaying and enabling a user to edit the document properties display the preview and the property of the selected document. Further, the user can select a plurality of documents in the document list area 504 and combine the documents into one binder file.

In addition, an output bar 502 displays location information of an item currently selected in the repository area 503 or the document list area 504. Moreover, the user interface of the dedicated application 311 includes an output list area 507 for displaying the information of peripheral devices, such as an image forming apparatus 511, and destination folders 512, and a menu bar 501 for setting the dedicated application 311. According to the user operation on the user interface of the dedicated application 311, a newly-arrived document confirmation target folder setting process and a newly-arrived document confirmation execution process to be described below are performed.

The form, the configuration of the area, and control with respect to the user interface of the dedicated application 311 illustrated in FIG. 5 are not limited. The user interface may be in any form as long as the necessary functions can be realized. For example, the document list area 504 and the output list area 507 may display a list of character strings, such as file names or device names for identifying the documents and the peripheral devices, in addition to the thumbnails and the icons.

Returning to FIG. 3, an operation information acquisition unit 313 in the dedicated application 311 acquires and notifies the main control unit 315 of the information operated by the user via the user interface of the dedicated application 311 displayed by the information display unit 312. A library determination unit 314 determines a connection destination setting when registering the library and when using the library. A storage unit 317 stores the setting information set by the user via the user interface of the dedicated application 311. A data transmission/reception unit 316 transmits and receives the data to and from the document management server 102 and the data management server 105, and notifies the main control unit 31 of the data.

The software configuration of the document management server 102 will be described below. In FIG. 3, a document management application 301 of the document management server 102 includes a control unit 302 and a storage unit 303, and performs generally-known functions of a document management application.

The software configuration of the data management server 105 will be described below. In FIG. 3, a data management application 321 of the data management server 105 includes a control unit 322, a data management unit 323, and a storage unit 324. The control unit 322 controls the data management application 321 of the data management server 105 according to the present exemplary embodiment. Further, the control unit 322 receives requests from the client PC 104 and the mobile terminal 106 via the network 103. The data management unit 323 registers, acquires, searches, and deletes the data stored in the storing unit 325. The RAM and the ROM in the data management server 105 are examples of the storage device.

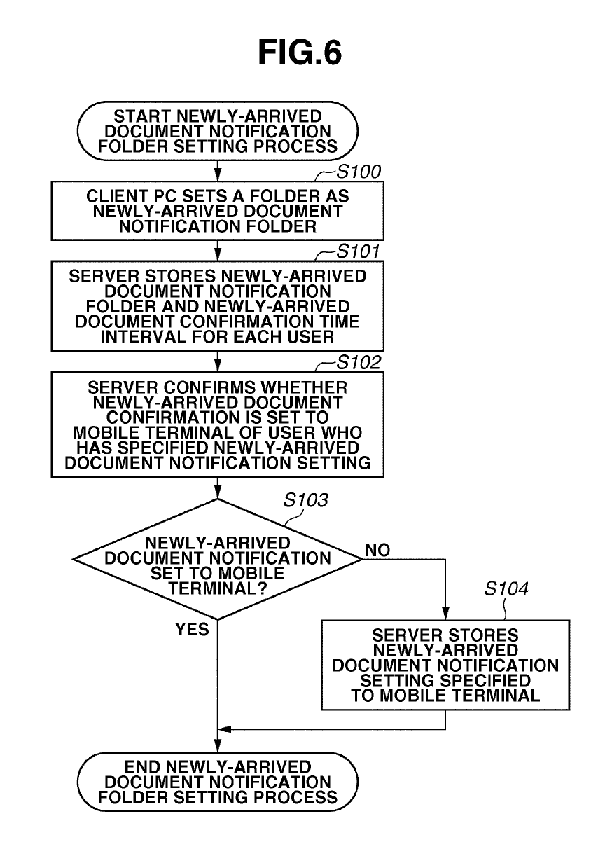

The user registers a folder for performing newly-arrived document notification when a document is newly registered or updated via the dedicated application 311 of the client PC 104. The document management server 102 then notifies the mobile terminal 106 of the similar settings. FIG. 6 is a flowchart illustrating the newly-arrived document notification target folder setting process according to the first exemplary embodiment. The flowchart will be described below with references to FIGS. 1 through 8.

In step S100, the user selects a folder in the repository area 503. If the user then clicks a right mouse button, the information display unit 312 displays a list of operations (not illustrated) that can be performed on the selected folder. The user further selects a “newly-arrived document notification target folder” from the operation list.

When the user determines the selection of the “newly-arrived document notification target folder” from the operation list, the operation information acquisition unit 313 notifies the main control unit 315 of the user determining the selection of the “newly-arrived document notification target folder”. The main control unit 315 stores in the storage unit 317 a folder path of the folder selected by the user and an interval of a newly-arrived document confirmation time. A default period is previously set to the newly-arrived document confirmation time interval (e.g., five minutes). However, the set time interval can be changed by a user operation. Further, the main control unit 315 instructs the data transmission/reception unit 316 to transmit newly-arrived document notification target folder information to the data management server 105.

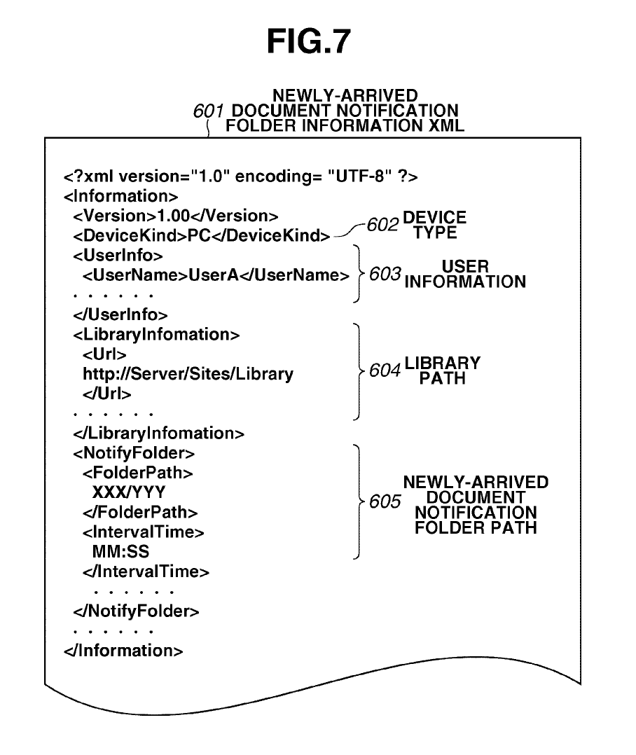

FIG. 7 illustrates an example of the newly-arrived document notification target folder information data which the main control unit 315 transmits to the data management server 105. Newly-arrived document notification target folder information XML 601 describes the newly-arrived document notification target folder information XML data to be transmitted. A newly-arrived document notification target folder path 605 corresponds to a folder path of the folder selected by the user. According to the present exemplary embodiment, the XML format is used. However, other formats may be used. For example, the information may be expressed in a JavaScript Object Notation (JSON) format.

In step S101 illustrated in FIG. 6, the control unit 322 in the data management server 105 receives a data transmission request from the client PC 104. The control unit 322 then analyzes the content of the newly-arrived document notification target folder information XML 601, and instructs the data management unit 323 to store the data. The data management unit 323 thus stores the data in the storage unit 324.

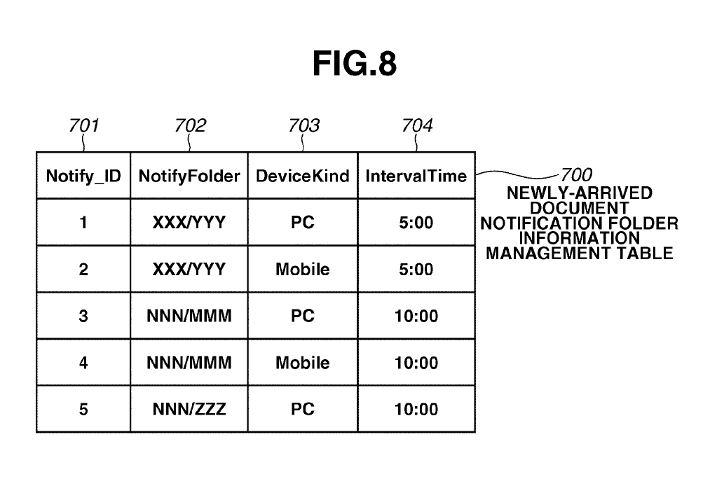

FIG. 8 illustrates an example in which the data of the newly-arrived document notification target folder information XML 601 is stored in a newly-arrived document notification target folder information management table 700. The newly-arrived document notification target folder information management table 700 includes a Notify_ID column 701 for uniquely identifying the newly-arrived document notification target folder information, and a NotifyFolder column 702 for storing the newly-arrived document notification target folder information. Further, the newly-arrived document notification target folder information management table 700 includes a DeviceKind column 703 for storing device information which has been set, and an IntervalTime column 704 for storing the newly-arrived document confirmation time interval.

In step S102, the control unit 322 in the data management server 105 checks with the data management unit 323 whether a newly-arrived document notification setting is specified to the mobile terminal 106 of the user who has specified the newly-arrived document notification setting. The data management unit 323 then confirms the data stored in the storage unit 324. In step S103, if the control unit 322 determines that the newly-arrived document notification setting is not specified to the mobile terminal 106 (NO in step S103), the process proceeds to step S104. In step S104, the control unit 322 instructs the data management unit 323 to store the newly-arrived document notification setting specified to the mobile terminal 106. The data management unit 323 thus stores the setting in the storage unit 324.

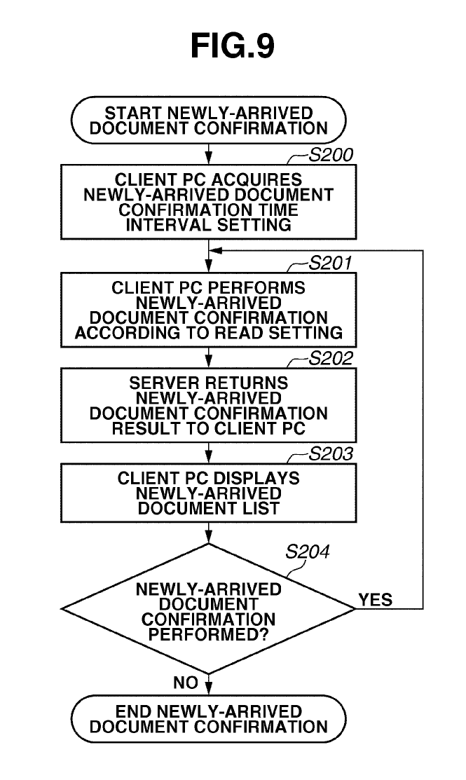

The user checks the document management server 102 via the dedicated application 311 of the client PC 104 whether there is a newly-arrived document. FIG. 9 is a flowchart illustrating the newly-arrived document confirmation process according to the first exemplary embodiment. The process will be described below with reference to FIGS. 1 through 9.

In step S200 in FIG. 9, the main control unit 315 in the client PC 104 acquires a newly-arrived document confirmation time interval from the newly-arrived document notification target folder setting stored in the storage unit 317. In step S201, the main control unit 315 checks the document management server 102 whether the newly-arrived document is registered in the newly-arrived document notification target folder according to the acquired newly-arrived document confirmation time interval.

In step S202, the control unit 302 in the document management server 102 returns to the client PC 104 the document list in the newly-arrived document notification target folder. In step S203, the main control unit 315 in the client PC 104 receives the document list and confirms the difference between the received document list and the previous document list. The main control unit 315 then instructs the information display unit 312 to display the newly-arrived document list which includes the difference as the newly-arrived document. Further, the main control unit 315 stores the displayed document list in the storage unit 317.

In step S204, the main control unit 315 determines whether the newly-arrived document confirmation is being performed. If the main control unit 315 determines that the dedicated application 311 of the client PC 104 is running (YES in step S204), the process returns to step S201. In step S201, the main control unit 201 performs the newly-arrived document confirmation again according to the setting acquired in step S200. The dedicated application 311 may be an application which is automatically executed as a service when the client PC 104 is activated. In such a case, the application may only include the newly-arrived document confirmation function. In addition, if the client PC 104 enters a sleep state, the newly-arrived document confirmation may be cancelled.

If the client PC 104 is confirming the newly-arrived document at every newly-arrived document confirmation time interval (i.e., every time the newly-arrived document confirmation time has elapsed), the document management server 102 issues the newly-arrived document notification to the client PC 104. If the client PC 104 stops the newly-arrived document confirmation, the document management server 102 issues the newly-arrived document notification to the mobile terminal 106. In other words, if the document management server 102 has not received the newly-arrived document confirmation from the client PC 104 even when the newly-arrived document confirmation time has elapsed, the document management server 102 notifies the mobile terminal 106 of the document newly arrived after the time the client PC 104 has confirmed the newly arrived document. On the other hand, if the document management server 102 has received the newly-arrived document confirmation from the client PC 104 when the newly-arrived document confirmation time has elapsed, the document management server 102 notifies the client PC 104 of the newly-arrived document.

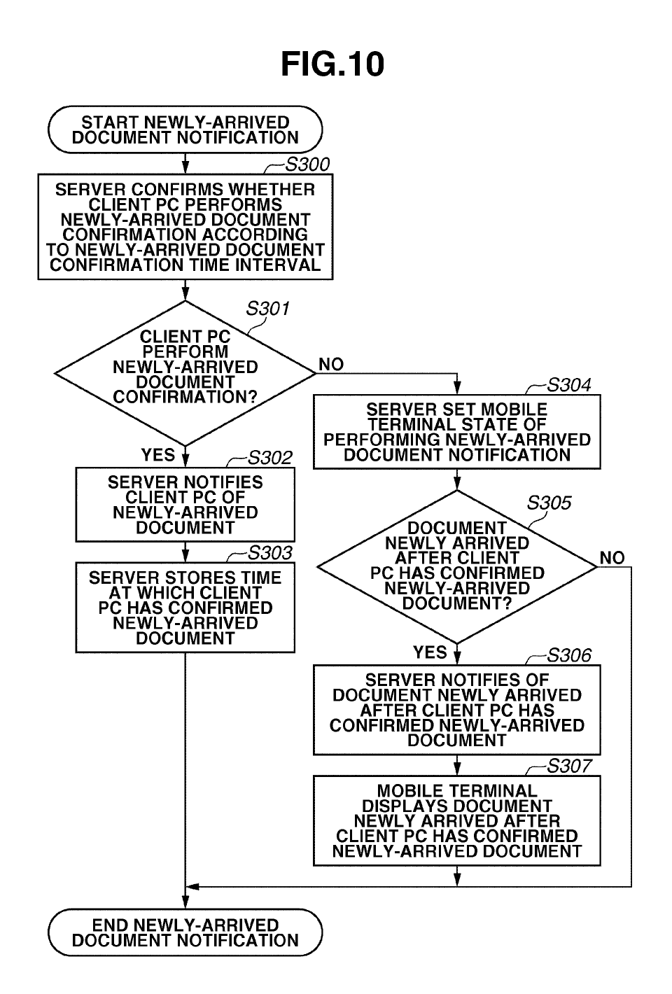

FIG. 10 is a flowchart illustrating the newly-arrived document notification process according to the first exemplary embodiment. The process will be described below with reference to FIGS. 1 through 11.

In step S300, the document management server 102 checks whether the client PC 104 is performing the newly-arrived document confirmation process according to the newly-arrived document confirmation time interval stored in the storage unit 324 in the data management server 105 from the client PC 104. The document server 102 determines by checking whether the client PC 104 is transmitting the confirmation at the newly-arrived document confirmation time intervals stored in step S101 of the flowchart illustrated in FIG. 6.

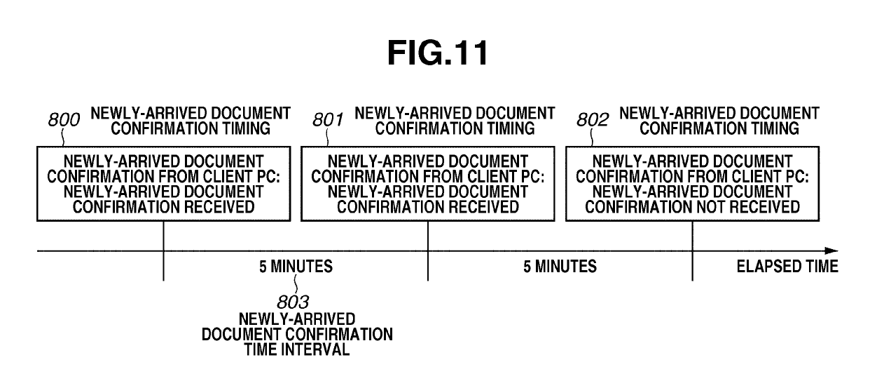

More specifically, the document management server 102 checks at each newly-arrived document confirmation timing as illustrated in FIG. 11, whether the client PC 104 is transmitting the newly-arrived document confirmation at every newly-arrived document confirmation time interval. In FIG. 11, newly-arrived document confirmation timing 800 and newly-arrived document confirmation timing 801 indicate a case where the document management server 102 has received the newly-arrived document confirmation and determined that the client PC 104 is transmitting the newly-arrived document confirmation. Newly-arrived document confirmation timing 802 indicates a case where the document management server 102 has not received the newly-arrived document confirmation and has determined that the client PC 104 is not performing the newly-arrived document confirmation.

In step S301, the document management server 102 determines whether the client PC 104 is performing the newly-arrived document confirmation process. If the document management server 102 determines that the client PC 104 is performing the newly-arrived document confirmation process (YES in step S301), the process proceeds to step S302. In step S302, the document management server 102 notifies the client PC 104 of the newly-arrived document. The process performed in step S302 is similar to the process performed in step S202 of the flowchart illustrated in FIG. 9. In step S303, the document management server 102 transmits to the data management server 105 the newly-arrived document confirmation time from the client PC 104. The data management server 105 thus stores the received newly-arrived document confirmation time in the storage unit 324 (i.e., newly-arrived document confirmation time storage).

On the other hand, if the document management server 102 determines that the client PC 104 is not performing the newly-arrived document confirmation process at every newly-arrived document confirmation time interval (NO in step S301), the process proceeds to step S304. In step S304, the document management server 102 sets up a state to transmit the newly-arrived document notification to the mobile terminal 106.

In step S305, the document management server 102 checks the data management server 105 whether there is a document which has been registered or updated after the time at which the client PC 104 last confirmed the newly-arrived document (i.e., the time stored in step S303).

If there is a document which has been registered or updated after the time the client PC 104 last confirmed the newly-arrived document (YES in step S305), the process proceeds to step S306. Instep S306, the document management server 102 transmits the newly-arrived document list to the mobile terminal 106. In such a case, it is not necessary for the document management server 102 to identify the type of the newly-arrived document and include it in the newly-arrived document list. More specifically, if the file requires to be processed on the client PC 104 side, such as editing of the file (e.g., a facsimile reply is necessary, or editing the files combined into one binder file), it is not necessary for the document management server 102 to include the file in the newly-arrived document list. Further, if the mobile terminal 106 is in a state unable to receive the newly-arrived document list, the document management server 102 does not issue the newly-arrived document notification, and re-issues the notification at the subsequent timing.

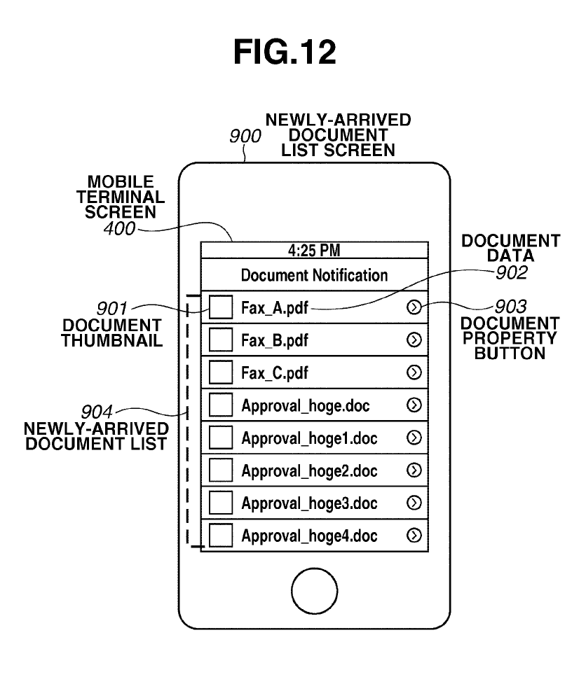

In step S307, the main control unit 334 in the mobile terminal 106 transmits and displays the received newly-arrived document list on the information display unit 332 via the data transmission/reception unit 336. For example, the main control unit 334 in the mobile terminal 106 displays a newly arrived document list 904 as illustrated in FIG. 12. A document thumbnail 901, document data 902, and a document property button 903 are displayed in the newly arrived document list 904.

The document management server 102 may notify, after notifying the mobile terminal 106 of the newly-arrived document, the client PC 104 of the information thereof. When the client PC 104 performs the newly-arrived document confirmation next time, the document management server 102 notifies the client PC 104 of the newly-arrived document (i.e., step S202 of the flowchart illustrated in FIG. 9) and of issuing the notification to the mobile terminal 106. When the client PC 104 then displays the newly-arrived document list (i.e., step S203 illustrated in FIG. 9), the client PC 104 may determine whether to display the newly-arrived document list or not based on a result of the notification issued to the mobile terminal 106 and the operation performed on the mobile terminal 106.

A second exemplary embodiment according to the present invention is different from the first exemplary embodiment in that the client PC 104 transmits to the document management server 102 information about whether the user has confirmed the newly-arrived document list notified to the client PC 104. Further, the document management server 102 determines a document to be notified to the mobile terminal 106 using the time at which the confirmation is performed.

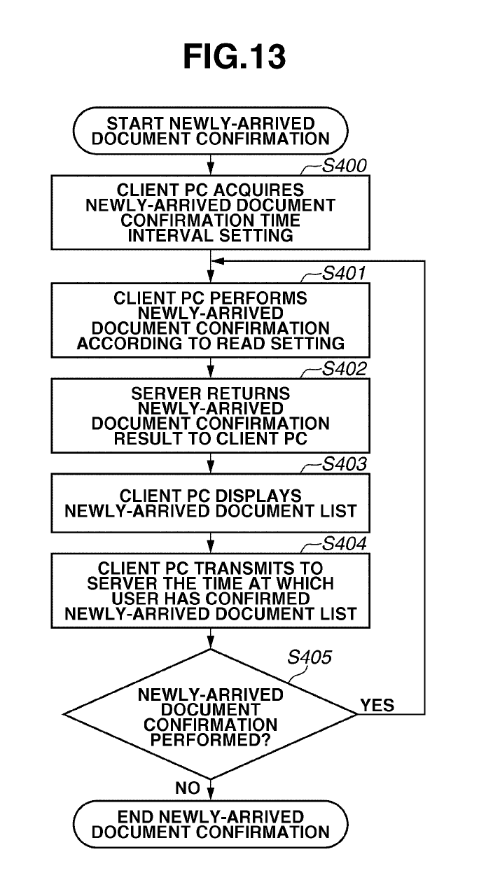

The user confirms the newly-arrived document in the document management server 102 via the dedicated application 311 of the client PC 104. FIG. 13 is a flowchart illustrating the newly-arrived document confirmation process according to the second exemplary embodiment. The process will be described below with reference to FIGS. 1 through 13.

In step S400, the main control unit 315 in the client PC 104 acquires the newly-arrived document confirmation time interval from the newly-arrived document notification target folder setting stored in the storage unit 317. In step S401, the main control unit 315 then checks the document management server 102 whether the newly-arrived document is registered in the target folder based on the acquired newly-arrived document confirmation time interval.

In step S402, the control unit 302 in the document management server 102 returns to the client PC 104 the document list in the newly-arrived document notification target folder. In step S403, the main control unit 315 in the client PC 104 receives the document list and confirms the difference between the received document list and the previous document list. The main control unit 315 then instructs the information display unit 312 to display the newly-arrived document list which includes the difference as the newly-arrived document. Further, the main control unit 315 stores the displayed document list in the storage unit 317.

In step S404, if the user confirms the newly-arrived document list displayed in step S403, the client PC 104 transmits the time when the user confirmed the list to the data management server 105. The data management server 105 thus stores the time in the storage unit 324. The stored time is regarded as a newly-arrived document confirmation process execution time, which will be described in detail below.

In step S405, the main control unit 315 in the client PC 104 determines whether the newly-arrived document confirmation is being performed. If the dedicated application 311 of the client PC 104 is running (YES in step S405), the process returns to step S401. In step S401, the main control unit 315 performs the newly-arrived document confirmation again according to the setting read in step S400.

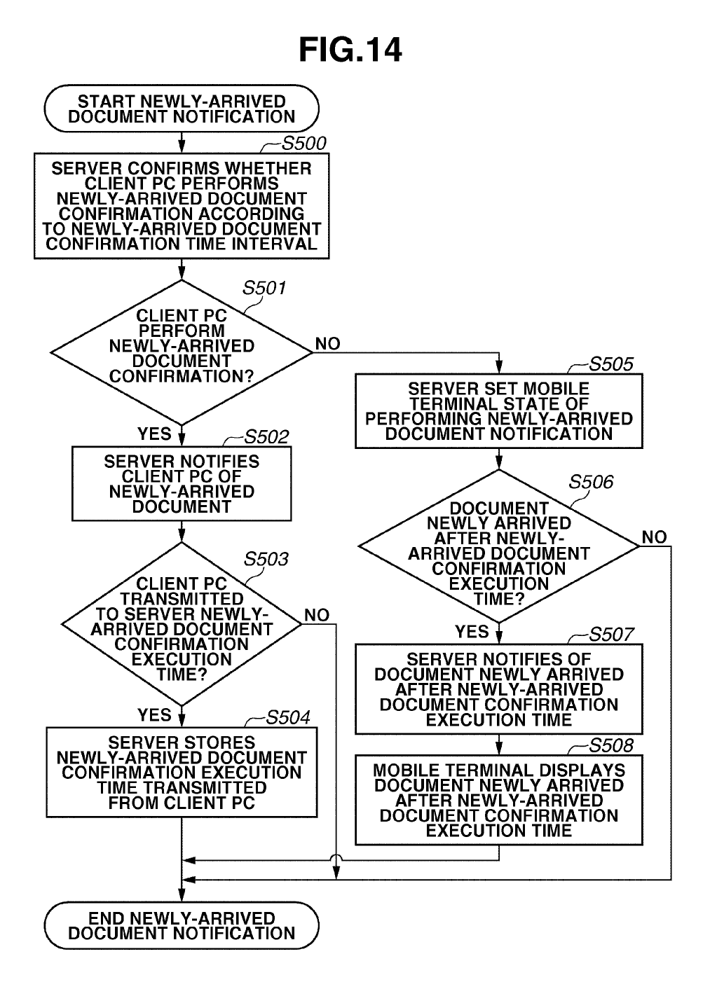

If the client PC 104 is confirming the newly-arrived document at every newly-arrived document confirmation time interval, the document management server 102 issues the newly-arrived document notification to the client PC 104. If the client PC 104 stops the newly-arrived document confirmation, the document server 102 issues the newly-arrived document notification to the mobile terminal 106. The document server 102 notifies of the document which newly arrived later than the newly-arrived document confirmation process execution time, which is different from the first exemplary embodiment. FIG. 14 is a flowchart illustrating the newly-arrived document notification process according to the second exemplary embodiment. The process will be described below with references to FIGS. 1 through 15.

In step S500, the document management server 102 checks whether the client PC 104 is performing the newly-arrived document confirmation process according to the newly-arrived document confirmation time interval stored in the storage unit 324 in the data management server 105 from the client PC 104.

In step S501, if the document management server 102 determines that the client PC 104 is performing the newly-arrived document confirmation process (YES in step S502), the process proceeds to step S502. In step S502, the document management server 102 notifies the client PC 104 of the newly-arrived document (i.e., performs a first notification). The process performed in step S502 is similar to the process performed in step S402 of the flowchart illustrated in FIG. 13.

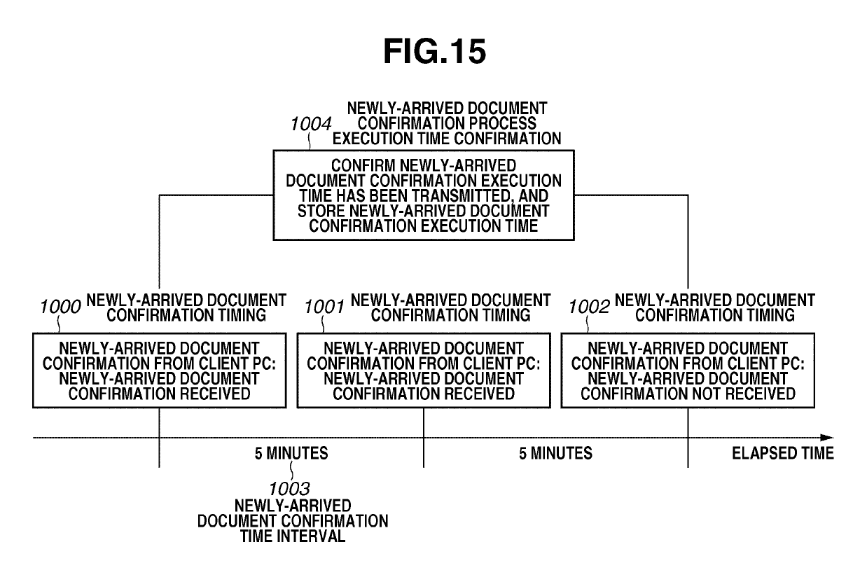

More specifically, the document management server 102 checks at each newly-arrived document confirmation timing as illustrated in FIG. 15, whether the client PC 104 is transmitting the newly-arrived document confirmation at every newly-arrived document confirmation time interval. In FIG. 15, newly-arrived document confirmation timing 1000 and newly-arrived document confirmation timing 1001 indicate a case where the document management server 102 has received the newly-arrived document confirmation and determined that the client PC 104 is transmitting the newly-arrived document confirmation. Newly-arrived document confirmation timing 1002 indicates a case where the document management server 102 has not received the newly-arrived document confirmation and has determined that the client PC 104 is not performing the newly-arrived document confirmation.

In step S503, the document management server 102 determines whether the newly-arrived document confirmation process execution time has been transmitted from the client PC 104. The transmission of the newly-arrived document confirmation process execution time from the client PC 104 is similar to the process performed in step S404 illustrated in FIG. 13. If the client PC 104 has transmitted the newly-arrived document confirmation process execution time (YES in step S503), the process proceeds to step S504.

More specifically, the document management server 102 checks whether the newly-arrived document confirmation process is being performed during a period of a newly-arrived document confirmation process execution time confirmation 1004 illustrated in FIG. 15. If the process is being performed, the document management server 102 performs the process in step S504.

In step S504, the document management server 102 transmits the newly-arrived document confirmation process execution time received from the client PC 104 to the data management server 105. The data management server 105 stores the received time in the storage unit 324 (i.e., stores the execution time).

On the other hand, in step S501, if the client PC 104 is not performing the newly-arrived document confirmation process at every newly-arrived document confirmation time interval (NO in step S501), the process proceeds to step S505. In step S505, the document management server 102 sets up a state to transmit the newly-arrived document notification to the mobile terminal 106.

In step S506, the document management server 102 checks whether there is a document which has been registered or updated after the time at which the client PC 104 last performed the newly-arrived document list confirmation process (i.e., after the newly-arrived document confirmation process execution time stored in step S504).

If there is such a document (YES in step S506), the process proceeds to step S507. In step S507, the document management server 102 notifies the mobile terminal 106 of the newly-arrived document (or transmits the newly-arrived document list to the mobile terminal 106) (i.e., performs a second notification). In such a case, it is not necessary for the document management server 102 to identify the type of the newly-arrived document and include it in the newly-arrived document list. More specifically, if the file requires to be processed on the client PC 104 side, such as editing of the file (e.g., a facsimile reply is necessary, or editing the files combined into one binder file), it is not necessary for the document management server 102 to include the file in the newly-arrived document list. Further, if the mobile terminal 106 is in a state unable to receive the newly-arrived document list, the document management server 102 does not issue the newly-arrived document notification, and re-issues the notification at the subsequent timing.

In step S508, the main control unit 334 in the mobile terminal 106 transmits and displays the newly-arrived document list received via the data transmission/reception unit 336 on the information display unit 332.

According to the present exemplary embodiment, the mobile terminal 106 can be notified of the document which is registered after the time the user last confirmed the newly-arrived document list, instead of after the client PC 104 has last performed the regular confirmation of the newly-arrived document. Accordingly, the appropriate newly-arrived document list can be displayed on the mobile terminal 106.

As described above, according to the exemplary embodiments of the present invention, the newly-arrived document notification can be transmitted (or issued) to the appropriate terminal (e.g., the client PC 104 or the mobile terminal 106).

Aspects of the present invention can also be realized by a computer of a system or apparatus (or devices such as a CPU or a MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-178474 filed Aug. 17, 2011, which is hereby incorporated by reference herein in its entirety.

What is claimed is:

1. A document management server apparatus comprising:
a determination unit configured to determine, when notifying of a newly-arrived document, whether a newly-arrived document confirmation is not received from a client apparatus even after a set newly-arrived document confirmation time has elapsed, and whether the newly-arrived document confirmation is received from the client apparatus when the set newly-arrived document confirmation time has elapsed; and
a notification unit configured to,
in the case where the determination unit determines that the newly-arrived document confirmation is not received from the client apparatus after the set newly-arrived document confirmation time has elapsed, send a notification to a mobile terminal apparatus of the document which newly arrives after a time at which the client apparatus confirmed the newly-arrived document, and
in the case where the determination unit determines that the newly-arrived document confirmation is received from the client apparatus when the set newly-arrived document confirmation time has elapsed, notify the client apparatus of the newly-arrived document.

2. The document management server apparatus according to claim 1, further comprising a newly-arrived document confirmation time storage unit configured to store in a storage device a time at which the client apparatus confirmed a newly-arrived document after the notification unit has notified the client apparatus of the newly-arrived document.

3. The document management server apparatus according to claim 2, wherein the newly-arrived document confirmation time storage unit transmits to a data management server apparatus the time at which the client apparatus confirmed the newly-arrived document, and causes a storage device in the data management server apparatus to store the time at which the client apparatus confirmed the newly-arrived document.

4. A document management server apparatus comprising:
a determination unit configured to, when notifying of a newly-arrived document, determine whether a newly-arrived document confirmation is received from a client apparatus when a set newly-arrived document confirmation time has elapsed;
a notification unit configured to, in the case where the determination unit determines that the newly-arrived document confirmation is received from the client apparatus when the set newly-arrived document confirmation time has elapsed, notify the client apparatus of the newly-arrived document;
a determining unit configured to, after the notification unit notified the client apparatus of the newly-arrived document, determine whether an execution time of a newly-arrived confirmation process is transmitted from the client apparatus; and
an execution time storage unit configured to, in the case where the determining unit determines that the execution time of the newly-arrived confirmation process is transmitted from the client apparatus, store in a storage device the time at which the client apparatus executed the newly-arrived confirmation process,
wherein the notification unit, in the case where the determination unit determines that the newly-arrived document confirmation is not received from the client apparatus when the set newly-arrived document confirmation time has elapsed, notifies a mobile terminal apparatus of the document which newly arrives after the time at which the client apparatus executed the newly-arrived confirmation process.

5. The document management server apparatus according to claim 4, wherein the execution time storage unit transmits to a data management server apparatus the time at which the client apparatus executed the newly-arrived document confirmation process, and causes a storage device in the data management server apparatus to store the time at which the client apparatus executed the newly-arrived document confirmation process.

6. A system including a document management server apparatus, a client apparatus, and a mobile terminal apparatus,
wherein the document management server apparatus includes:
a determination unit configured to determine, when notifying of a newly-arrived document, whether a newly-arrived document confirmation is not received from the client apparatus even after a set newly-arrived document confirmation time has elapsed, and whether a newly-arrived document confirmation is received from the client apparatus when the set newly-arrived document confirmation time has elapsed; and
a notification unit configured to,
in the case where the determination unit determines that the newly-arrived document confirmation is not received from the client apparatus after the set newly-arrived document confirmation time has elapsed, notify the mobile terminal apparatus of a document which newly arrives after a time at which the client apparatus confirmed a newly-arrived document, and
in the case where the determination unit determines that the newly-arrived document confirmation is received from the client apparatus when the set newly-arrived document confirmation time has elapsed, notify the client apparatus of a newly-arrived document,
wherein the client apparatus includes a display unit configured to, in the case where the document management server apparatus is notified of the newly-arrived document, display the newly-arrived document, and
the mobile terminal apparatus includes a display unit configured to, in the case where the document management server apparatus is notified of the newly-arrived document, display the newly-arrived document.

7. A system including a document management server apparatus, a client apparatus, and a mobile terminal apparatus,
wherein the document management server apparatus includes:
a determination unit configured to determine, when notifying of a newly-arrived document, whether a newly-arrived document confirmation is received from a client apparatus when a set newly-arrived document confirmation time has elapsed;
a notification unit configured to, in the case where the determination unit determines that the newly-arrived document confirmation is received from the client apparatus when the set newly-arrived document confirmation time has elapsed, notify the client apparatus of the newly-arrived document;
a determining unit configured to determine, after the notification unit notified the client apparatus of the newly-arrived document, whether an execution time of a newly-arrived confirmation process is transmitted from the client apparatus; and
an execution time storage unit configured to, in the case where the determining unit determines that the execution time of the newly-arrived confirmation process is transmitted from the client apparatus, store in a storage device the time at which the client apparatus executed the newly-arrived confirmation process,
wherein the notification unit, in the case where the determination unit determines that the newly-arrived document confirmation is not received from the client apparatus when the set newly-arrived document confirmation time has elapsed, notifies the mobile terminal apparatus of a document which newly arrives after the time at which the client apparatus executed the newly-arrived confirmation process,
wherein the client apparatus includes a display unit configured to, in the case where the document management server apparatus notifies of a newly-arrived document, display the newly-arrived document, and
the mobile terminal apparatus includes a display unit configured to, in the case where the document management server apparatus notifies of a newly-arrived document, display the newly-arrived document.

8. A method performed by a document management server apparatus for notifying of a newly-arrived document, the method comprising:
determining, when notifying of a newly-arrived document, whether a newly-arrived document confirmation is not received from a client apparatus even after a set newly-arrived document confirmation time has elapsed, and whether a newly-arrived document confirmation is received from the client apparatus when the set newly-arrived document confirmation time has elapsed; and
in the case where it is determined that the newly-arrived document confirmation is not received from the client apparatus after the set newly-arrived document confirmation time has elapsed, notifying a mobile terminal apparatus of a document which newly arrives after a time at which the client apparatus confirmed the newly-arrived document, and notifying, and
in the case where it is determined that the newly-arrived document confirmation is received from the client apparatus when the set newly-arrived document confirmation time has elapsed, notifying the client apparatus of the newly-arrived document.

9. A method performed by a document management server apparatus for notifying of a newly-arrived document, the method comprising:
determining, when notifying of a newly-arrived document, whether a newly-arrived document confirmation is received from a client apparatus when a set newly-arrived document confirmation time has elapsed;
in the case where it is determined that the newly-arrived document confirmation is received from the client apparatus when the set newly-arrived document confirmation time has elapsed, notifying the client apparatus of the newly-arrived document;
determining, after notifying the client apparatus of the newly-arrived document, whether an execution time of a newly-arrived confirmation process is transmitted from the client apparatus;
in the case where it is determined that the execution time of the newly-arrived confirmation process is transmitted from the client apparatus, storing in a storage device the time at which the client apparatus executed the newly-arrived confirmation process; and
in the case where it is determined that the newly-arrived document confirmation is not received from the client apparatus when the set newly-arrived document confirmation time has elapsed, notifying a mobile terminal apparatus of a document which newly arrives after the time at which the client apparatus executed the newly-arrived confirmation process.

10. A method for notifying of a newly-arrived document performed by a system including a document management server apparatus, a client apparatus, and a mobile terminal apparatus, the method comprising:
causing the document management server apparatus to determine, when notifying of the newly-arrived document, whether a newly-arrived document confirmation is not received from the client apparatus even after a set newly-arrived document confirmation time has elapsed, and whether the newly-arrived document confirmation is received from the client apparatus when the set newly-arrived document confirmation time has elapsed; and
causing the document management server apparatus to
in the case where it is determined that the newly-arrived document confirmation is not received from the client apparatus even after the set newly-arrived document confirmation time has elapsed, notify the mobile terminal apparatus of the document which newly arrives after the time at which the client apparatus confirmed the newly-arrived document, and
in the case where it is determined that the newly-arrived document confirmation is received from the client apparatus when the set newly-arrived document confirmation time has elapsed, notify the client apparatus of the newly-arrived document;
causing the client apparatus, in the case where the document management server apparatus notifies of a newly-arrived document, to display the newly-arrived document; and
causing the mobile terminal apparatus, in the case where the document management server apparatus notifies of the newly-arrived document, to display the newly-arrived document.

11. A method for notifying of a newly-arrived document performed by a system including a document management server apparatus, a client apparatus, and a mobile terminal apparatus, the method comprising:
causing the document management server apparatus to determine, when notifying of the newly-arrived document, whether a newly-arrived document confirmation is received from the client apparatus when a set newly-arrived document confirmation time has elapsed;
causing the document management server apparatus to, in the case where it is determined that the newly-arrived document confirmation is received from the client apparatus when the set newly-arrived document confirmation time has elapsed, notify the client apparatus of the newly-arrived document;
causing the document management server apparatus to determine, after notifying the client apparatus of the newly-arrived document, whether an execution time of a newly-arrived confirmation process is transmitted from the client apparatus;
causing the document management server apparatus to, in the case it is determined that the execution time of the newly-arrived confirmation process is transmitted from the client apparatus, store in a storage device the time at which the client apparatus executed the newly-arrived confirmation process;
causing the document management server apparatus to, in the case where it is determined that the newly-arrived document confirmation is not received from the client apparatus even after the set newly-arrived document confirmation time has elapsed, notify the mobile terminal apparatus of the document which newly arrives after the time at which the client apparatus executed the newly-arrived confirmation process and is stored in the storage device; and
causing the client apparatus, in the case where the document management server apparatus notifies of the newly-arrived document, to display the newly-arrived document; and
causing the mobile terminal apparatus, in the case where the document management server apparatus notifies of the newly-arrived document, to display the newly-arrived document.

12. A non-transitory computer readable storage medium storing a program for causing a computer to execute a method comprising:
determining, when notifying of a newly-arrived document, whether a newly-arrived document confirmation is not received from a client apparatus even after a set newly-arrived document confirmation time has elapsed, and whether a newly-arrived document confirmation is received from the client apparatus when the set newly-arrived document confirmation time has elapsed; and
in the case where it is determined that the newly-arrived document confirmation is not received from the client apparatus after the set newly-arrived document confirmation time has elapsed, notifying a mobile terminal apparatus of a document which newly arrives after a time at which the client apparatus confirmed the newly-arrived document, and notifying,
in the case where it is determined that the newly-arrived document confirmation is received from the client apparatus when the set newly-arrived document confirmation time has elapsed, notifying the client apparatus of the newly-arrived document.

13. A non-transitory computer readable storage medium storing a program for causing a computer to execute a method comprising:
determining, when notifying of a newly-arrived document, whether a newly-arrived document confirmation is received from a client apparatus when a set newly-arrived document confirmation time has elapsed;
in the case where it is determined that the newly-arrived document confirmation is received from the client apparatus when the set newly-arrived document confirmation time has elapsed, notifying the client apparatus of the newly-arrived document;
determining, after notifying the client apparatus of the newly-arrived document, whether an execution time of a newly-arrived confirmation process is transmitted from the client apparatus;
in the case where it is determined that the execution time of the newly-arrived confirmation process is transmitted from the client apparatus, storing in a storage device the time at which the client apparatus executed the newly-arrived confirmation process; and
in the case where it is determined that the newly-arrived document confirmation is not received from the client apparatus when the set newly-arrived document confirmation time has elapsed, notifying a mobile terminal apparatus of a document which newly arrives after the time at which the client apparatus executed the newly-arrived confirmation process.
